(19) United States
(12) Patent Application Publication
(10) Pub. No.: US 2008/0235108 A1
(43) Pub. Date: Sep. 25, 2008

(54) Electronic Secure Authorization for Exchange Application Interface Device (eSafeAID)

(76) Inventors: Michael Kulakowski, Jackson, NJ (US); Robert Kulakowski, (US)

Correspondence Address: MICHAEL KULAKOWSKI, 5 CARLSON COURT, JACKSON, NJ, 08527, US

(21) Appl. No.: 12/077,618

(22) Filed: Mar. 21, 2008

Related U.S. Application Data
(60) Provisional application No. 60/919,326, filed on Mar. 21, 2007.

(51) Int. Cl. G06Q 30/00; H04L 9/32; G08G 1/123

(52) U.S. Cl. 705/26; 705/67; 705/5; 705/6; 340/994

(57) ABSTRACT

The electronic Secure Authentication for Exchange Application Interface Device (eSafeAID) invention provides a means for digital communication devices such as: high definition televisions, set-top boxes, television remote control devices, video remote control devices, Personal Computers, Notebook computers, cellular telephones, RFID Readers, Personal Digital Appliances, etc., to conduct ‘eCommerce—electronic digital shopping experiences and purchase transactions’ within a network environment (preferably an authenticated Secure Telecommunication Network) thereby facilitating customers to purchase, order, reserve products, locate products and services, or participate in auctions, or order, schedule, reserve, or purchase services, and or acquire product or service details, incentive offers, service offers, travel information, etc. while viewing media programming.

Distribution of eSafeAID eCommerce Content utilizes Product Identifiers (900) synchronized to Product Instance Placement (901) intervals presented to customers on an eSafeAID media display device during the viewing of television programs, movies, sporting events, etc.

The present application claims the benefit of the “electronic Secure Authentication for Exchange Application Interface Device (eSafeAID)” U.S. provisional patent application No. 60/919,326 filed Mar. 21, 2007 which is incorporated herein by reference in its entirety.

### BACKGROUND OF THE INVENTION

This invention utilizes advances in digital television, home computer networks, wireless telecommunication networks, cellular telephone capabilities, electronic digital devices, Global Positioning Systems, and media delivery technologies establishing a rich multi-technology digital conversion capability between a consumer's viewable media programming content, a consumer digital communication device, and various product manufactures, product distributors and product retailers, product auction entities, entertainment events by providers and sponsors, movie, television, or DVD originating from programming studios, broadcasters, and distributors, sporting events from providers and sponsors, various service providers, vacation and tourism providers, —offering customers the ability to directly purchase, order, reserve such products, locate products, or participate in product/service auctions, or order, schedule, reserve, or purchase such services, and or acquire product or service details, incentive offers, service offers, travel offers and information, entertainment and sporting event information, locate services, etc. while viewing media programming.

### BRIEF DESCRIPTION OF THE DRAWINGS

FIG. 1—The eSafeAID System presenting an eSafeAID Sports Event Auction, a media display device, and conforming devices.

FIG. 2—The eSafeAID System presenting an eSafeAID Original Content Product Identifier and Product Instance Placement association between an Identifier to a product or service where the Identifier is displayed on an eSafeAID conforming media display device and accessible by an eSafeAID controller device.

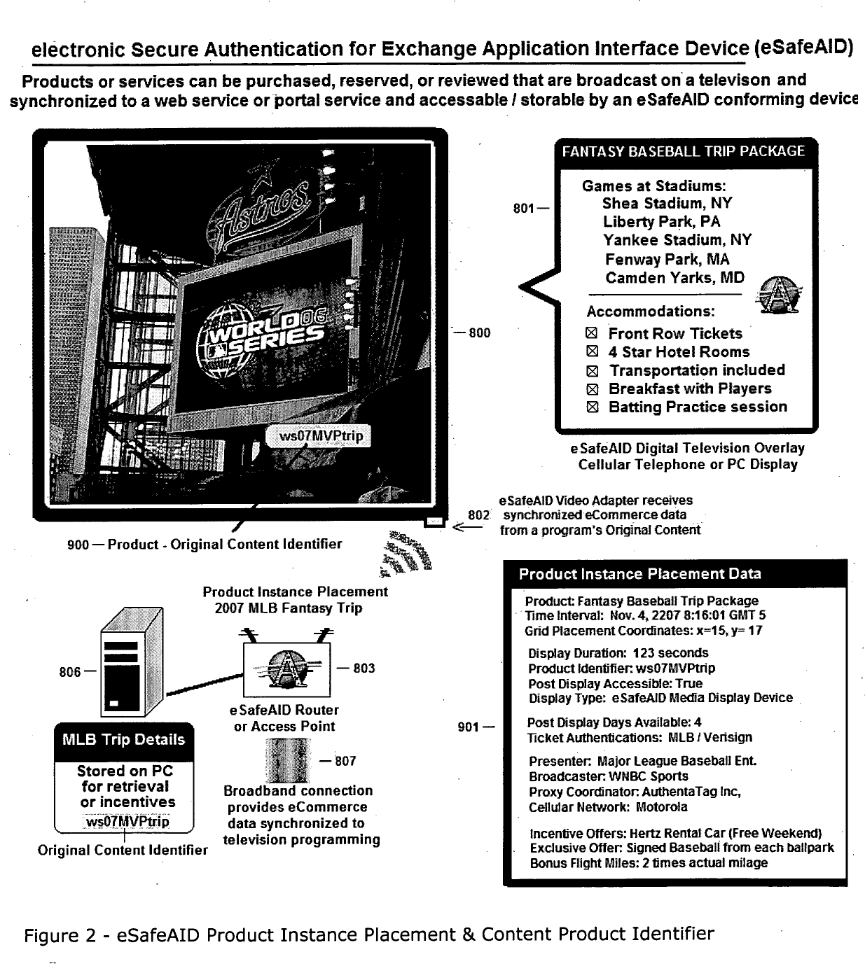

FIG. 3—eSafeAID Product Identifier Filter depicts the filtering of eSafeAID Original Content Product Identifier to satisfy the diverse individual interest of different family members.

FIG. 4—eSafeAID Content Product Identifier Locator presents the usage of an RFID Reader to locate products associated with eSafeAid Original Content Identifiers.

### BRIEF SUMMARY OF THE INVENTION

This invention provides a means for specific digital electronic communication devices to function within a Purchase Authentication System (PAS) comprised of the technologies presented within the patent applications previously filed by Michael Kulakowski and Robert Kulakowski, namely,
Secure Authentication System for Collectable and Consumer Items
(U.S. patent application Ser. No. 11/157,282)
Secure RFID Authentication System
(U.S. patent application Ser. No. 11/268,162)
Secure RFID Authentication System using non-trusted communications agents
(U.S. patent application Ser. No. 11/728,792)
Direct Incentive Authentication Link (DIAL) System
(U.S. patent application Ser. No. 11/881,506)
electronic Secure Authentication For Exchange Buyer Assurance System (eSafeBay)
(U.S. patent application Ser. No. 12/002,811)
electronic Secure Authentication For Exchange Buying System (eSafeBuy)
(U.S. patent application Ser. No. 12/002,810)

Employing a plurality of the technologies contained within the aforementioned patent applications, products offered for sale to consumers are (optionally/optimally) authenticated prior to the product's purchase against counterfeiting, piracy, or unlawfulness by enacting an RFID “Cryptographic Authentication Challenge” or another secure authentication method. Consumers conduct ‘eCommerce—electronic digital shopping experiences and purchase transactions’ across an eSafeAID network environment (comprised of an authenticated Secure Telecommunication Network). Consumers can securely purchase, order, reserve products, or participate in auctions, or order, schedule, reserve, or purchase services, and or acquire product or service details, incentive offers, service offers, travel information, make reservations, etc. while viewing media programming and content on an eSafeAID media display device within a real-time time-frame.

### DETAILED DESCRIPTION OF THE INVENTION

Within this application “Conforming Devices” are defined as digital electronic devices that are capable of communicating messages supporting the features and functions presented in the prior art contained within the aforementioned patents in such fashion that any combination of electronic communication devices consisting of, but not limited to the following: a cellular telephone (805), an RFID Reader, Secure ID reading, Personal Digital Appliance PDA, Personal Computer (806), Laptop or Notebook computer, electronic wallet, television (800), personal video player, digital television (800), high definition television (800), set-top box, satellite radio, satellite television (800), satellite internet, satellite telecommunication device, video gaming device, gaming device, gaming controller, video remote control device (804), television remote control device (804), GPS—Global Positioning System, and/or future electronic digital device combining one or more of the functionality currently provided by any single device, or any other form of electronic product with or without Radio Frequency Identification (RFID) technology support (RFID reading or Secure ID reading) that can be used to conduct ‘electronic digital shopping experiences and purchase transactions’ in a network environment and preferably an authenticated Secure Telecommunication Computer Network. In addition, the domain of “Conforming Devices” can be extended to devices that do not support the messaging and communications necessary to provide the benefits of this invention by providing proxy interface servers that interface non-Conforming Devices to the messaging, protocols, and technology required to provide these invention's benefits to the non-Conforming Device and will be called Proxy Server technology in this patent application. This means that web services or server side technology can provide the processing necessary to allow non-Conforming Devices to enjoy the benefits of this invention.

Distribution of eSafeAID Content related eCommerce data, services, incentive offers, provisions of product details, and the ability to purchase products, participate in auctions, order, schedule, reserve, or purchase services, etc., is conducted via customer interaction with eSafeAID conforming devices and non-Conforming Devices that present Product Identifiers (900) synchronized to Product Instance Placement (901) intervals to customers on an eSafeAID media display device through the usage of a secure eSafeAID Media Adapter (802). (The eSafeAID Media Adapter will be the subject of an upcoming patent application filing).

In this patent application the term eSafeAID media display device means any form of electronic or digital device, such as, but not limited to—a digital television (800), video screen (800), computer screen, cellular telephone display, video projector, DVD player, blue ray player, mp3 player, audio or video player, film display apparatus, or any future device capable of displaying media in video and/or audio format.

In this patent application the term Content means any form of video (808), audio, text, digital or conventional images, printed output, or display of any type including but not limited to any type of content that can be displayed on a television (800), video screen (800), projector, DVD player, film, digital storage of video or images or music, television (800), personal video display device, computer (806), Personal Digital Assistant, cellular telephone (805) or any other type of device with an audio or visual display device.

In this patent application the term Identifier (900) is used to define the process or method or way of identifying a particular item such as a piece of clothing or a fashion accessory, or a work of art, or a piece of jewelry, or a house hold appliance, or an article of any type, or a piece of equipment, or an item or article used in sporting event, or tickets to sporting and entertainment events, identify items in movies such as shoes or clothes or accessories, or curtains or furniture or equipment or a trip that one of the actors or actresses or directors are involved with or any tangible or non-tangible item or article presented, received or is associated with a serial number or other type of identifier. Identifiers can be added to any piece of Content or items contained within a scene of the content being displayed including Movie, Television Program, Sporting Event (808), Entertainment Event, Commercial, News, Game Show, Documentary, or an Event, services, financial services, vacations, trips, items of any type, props, gear, concert, etc., related to the movie, television program, entertainment event, sporting event, product, advertisement, and offers or incentives of any type including offers from retailers or manufacturers or producers, promoters, or distributors or others. The purpose of an Identifier is to create a unique value or number or identifier that can be used when offering an item for sale, or uniquely identifying an item for future reference or to provide an identifier for a service or an offer or product of any type. “Identifiers” (with capital ‘I’) are used in this invention to create unique values for products or offers, etc., so that the product or offer can be later uniquely identified using the Identifier.

Additionally, Identifiers may also be stealth in nature, by being invisible to the naked eye when affixed to real-life physical products, paintings, art, designer goods, sonic vantage points, amusement parks, sporting events, entertainment events, etc., that are presented or contained within content for broadcasts, television programs, movies, etc., or captured by digital photographs, video recordings, audio recording, and transmitted to or presented on conforming eSafeAID media display devices. A product's “stealth” Identifier becomes electronically visible and accessible by an eSafeAID conforming digital device and provides a (secure) digital link to the product or service so identified, product finding and location services, service request, incentive offers, and/or eventual product authentication processes detailed in the aforementioned patents.

There can be many identifiers associated with Original Content, for example when the Original Content is an advertising photo for a beach resort, or a movie including a beach scene Identifiers created for the photo or scene, for example can include one or more of the following:
i. Identifiers of a vacation package to the beach in the scene or nearby hotels, resorts, travel accommodations, etc.
ii. Identifiers for each of the swimsuits worn by the girls in a sane
iii. Identifiers for each of the swim trunks worn by the surfers in the scene
iv. Identifiers for each of the surf boards being used by the surfers in the scene
v. Identifiers for any other products associated with the scene or scenes from the original Content
vi. Identifiers for the actual items used from the set or during the production of the original Content for example Identifiers for the actual surf boards or bikinis used by the actors and actresses
vii. Identifiers for any of the production material, scripts, story boards, still shots, etc.

The above examples serve to provide a broad extent of some indication and application of Identifiers and not to limit the scope of the total universe of Identifiers which can be very broad in scope and applicability.

This invention establishes a means for any of the “Conforming Devices” including Proxy Server technology to electronically communicate amongst each other to create a “virtual shopping mall”, “an information portal”, “a distributed transaction environment”, “an authenticated digital auction” and a means for Retailers, Manufacturers, Distributors, or Promotional Companies to communicate with potential customers and other interested parties to provide incentives and product details necessary to identify a product, identify a product with regards to the use or application or identification of a product, order a product, reserve a product for later purchase, complete a purchase transaction, participate in an auction, and/or order a desired service, or schedule a service. This technology allows individuals to identify a product with regards to the use or application or identification of a product such as identifying a particular ball or piece of equipment used in sporting event, identify items in movies, newspapers, magazines, on television, in the news, in public locations, and in any other location or form whereby a person may want to identify an item for purchase, informational, historic, education, curiosity or for any other reason.

Within this application, a reference to an auction (801), participation within an auction, placing of a bid, acquisition of a product by placing a winning bid on an auctioned product, (in accordance with the specifications presented within the eSafeBAY patent application) shall be identified simply as a “product purchase”. In addition, any form of normal commerce (conventional, in person, via telephone, kiosk, or on-line web based) is also included in the use of the term “product purchase” and includes product identification where an actual product purchase is not completed but the item is identified for information purposes.

An electronic Secure Authentication For Exchange Application Interface Device (eSafeAID) is comprised of the electronic circuitry, computer networks (807) and computer systems (807) and software applications to search, identify, display and purchase products in several configurations such as: Movie, Television Program, Sporting, Commercial, News, Game Show, Documentary, or an Event of any type. This invention provides the technology to identify items, directly and purchase, or reserve, add to a gift list, share details about, or participation in an auction, etc., for acquiring associated products.

In addition, this invention identifies and displays identifiers for services, financial services, vacations, trips, items of any type, props, gear, etc., related to the movie, television program, entertainment event, sporting event, advertising, including retailers, manufacturers, producers, promoters, broadcasters, media providers, etc. This identification and display pro can be performed in either an un-secure or a secure authenticated way using a conforming eSafeAID device, or via eSafeAID Proxy Service. The un-secure method of identification does not need to authenticate an RFID identifier associated with an item. The un cure method can be accessed via a trusted secure web site with known trusted credential or it can be accessed via an un cure website. The un cure method will not have a visible (or audible) indicator that identifies the site as a “trusted” eSafeAID site thus providing access similar to the current day web browser identifier for e-commerce websites that display a small ‘lock’ icon to indicate a Secure Socket Layer (SSL) verified website or transaction.

Product Instance Placement “PIP” (901) is a time-based interval coordination system whereby this invention adds or associates an Identifier with a product or service and the Identifier can be displayed using an eSafeAID conforming controller device or Proxy Service to either identify, purchase, reserve, locate, order, acquire data about, capture the product's details in real-time during an media program, television program, movie or media streaming, television program, sporting event, news, game show, entertainment event, movie, documentary, infomercial, commercial, song, or thereafter during playback or replay or inclusion of the original event containing an Identifier in a news clip or talk program or other program including a video game, documentary, viewing within DVD movies, etc., or any media format providing a means to display the original content.

The time bases element of the PIP system is based on generating new Identifiers for different items being identified and these Identifiers can be synchronized to events in the Content or asynchronous to events in the Content (preferably distributed via ‘authenticated’ distributed broadband networks (807), authenticated routers (803), authenticated cellular telephone network, broadcast networks, etc.) For example, in a football game when there is a new football put into play the identifier for the new football will change accordingly. The coordination of such changes can be performed at any point in the PIP processing workflow depending upon which event, sporting event, advertising, including retailers, manufacturers, producers, promoters, broadcasters, media providers, etc. This identification and display process can be performed in either an un-secure or a secure authenticated way using a conforming eSafeAID device, or via eSafeAID Proxy Service. The un-secure method of identification does not need to authenticate an RFID identifier associated with an item. The un-secure method can be accessed via a trusted secure web site with known trusted credential or it can be accessed via an un-secure website. The un-secure method will not have a visible (or audible) indicator that identifies the site as a “trusted” eSafeAID site thus providing access similar to the current day web browser identifier for e-commerce websites that display a small ‘lock’ icon to indicate a Secure Socket Layer (SSL) verified website or transaction.

Product Instance Placement “PIP” (901) is a time-based interval coordination system whereby this invention adds or associates an Identifier with a product or service and the Identifier can be displayed using an eSafeAID conforming controller device or Proxy Service to either identify, purchase, reserve, locate, order, acquire data about, capture the product's details in real-time during an media program, television program, movie or media streaming, television program, sporting event, news, game show, entertainment event, movie, documentary, infomercial, commercial, song, or thereafter during playback or replay or inclusion of the original event containing an Identifier in a news clip or talk program or other program including a video game, documentary, viewing within DVD movies, etc., or any media format providing a means to display the original content.

The time bases element of the PIP system is based on generating new Identifiers for different items being identified and these Identifiers can be synchronized to events in the Content or asynchronous to events in the Content (preferably distributed via ‘authenticated’ distributed broadband networks (807), authenticated routers (803), authenticated cellular telephone network, broadcast networks, etc.) For example, in a football game when there is a new football put into play the identifier for the new football will change accordingly. The coordination of such changes can be performed at any point in the PIP processing workflow depending upon which method is used to link product or service offering web pages with Content Identifiers.

The PIP process function in the follow way:
1. Content of any form is recorded or prepared or broadcasted for display on a display device (preferably an eSafeAID media display device) such as a TV, mobile phone screen, computer, cellular telephone, controller, digital image, or printed on paper, etc.
2. For products included in the Original Content or offers associated with Original Content, the creation of Identifier data and the association of Identifier data with Original Content may occur in one of many different ways, including but not limited to the following:
   a. added to the Original Content as part of the original content or as added data to the Content file such as additional data being added to an MPEG file, or additional data being added to a compressed video file or compressed video image or other type of digital file containing content or Identifiers
   b. real-time coordination between a web site and the Original Content such that if a person goes to the web site associated with the Original Content at the time the Original Content is being broadcasted the viewer will see web pages associated with the scenes being broadcasted at that time
   c. products, digital brochures, scenes, displays, costumes, props, exhibits, scenic vantage points, etc., that are digitally photographed or video recorded at a resort, theme park, historic location, amusement park, estate, show room, museum, will have an embedded Identifier (undetectable to the naked eye) but viewable and accessible by an eSafeAID conforming device
   d. web site data is created during web page creation that is coordinated with one or more scenes or images associated with the Original Content in time synchronous order where the page or pages are associated with different time epochs of the original Content or without any time synchronization.
   e. during broadcast of the Original Content an overlay (802) or link that directs the viewer to purchase products directly during the broadcast, or from a web site or shopping channel whereby products and offers associated with the Original Content can be found allowing product sales, reservations, auctioning, and offer fulfillment to be regionalized. Retailers or manufacturers or distributors offering the products are identified in accordance with the customer's predefined location and associated preferences, whereby a New York customer is presented with product purchase opportunities from New York City's Macys while a Chicago customer is presented with product purchase opportunities from Chicago's Sears. Additionally, Original Content purchase details, incentive and service offerings will provide customers with links to local web sites, service providers, entertainment tickets, sporting events, restaurants, travel tickets, travel reservations, etc. Additionally, Original Content filters may provide links to a customer's preferred (regional) locations web sites, retailers, service providers, entertainment tickets, sporting events, restaurants, travel tickets, travel reservations, etc, to accommodate travelers, vacationers, visitors, out of state students, or to present access to web service hosted by the Content producer, or a redirector engine that redirects an individual to a web site for the country, region of the country where the viewer lives, or wishes to be associated with, etc.)
   f. or, for the creation of an offer web page for Original Content with index or information to identify a program or show or picture etc.
   g. or, at a separate website, web pages or informational pages for the Original Content that are so created whereby the web pages or informational pages include Identifiers for items offers, etc. associated with the original Content scene. For example, when the original Content has a scene of three friends talking, the web page for this scene would have a video image similar to the Original Content scene of the three friends talking with the web page containing product or offer Identifiers. A single webpage or multiple web pages can be produced with Identifiers for items or offers in the original Content with or without original video scenes from the original Content. Multiple web pages can be created for a scene or multiple scenes from the Original Content. There can be one or more Identifiers for the Original Content as appropriate
   h. or, in a separate piece of content whereby Original Content scene data is used as a background with an index of items offered for the items associated with the original Content.
   i. or, in a separate program such as a separate video channel or separate images that are created with video or content from the Original Content and the separate program can include to Identifiers or links to the separate program associated the original Content
3. Using the Identifiers in the processing of services associated with the product or service associated with or associated by the Identifier. For example, a product is offered and the processing for this invention can use (directly or indirectly) the Identifier when offering services at an e-commerce or auction site such as:
   a. Using the Identifier to uniquely identify a product
   b. Using the Identifier as an indicator on a website offering the products used in an event or products found in any type of Content whereby the website is not part of the Content.
   c. Using the Identifier as part of an telephone based order process
   d. Using the Identifier as part of an e-commerce identification process
   e. Using the Identifier to allow the pedigree of the product to be verified.
   f. Using the Identifier to allow additional product specifications to be obtained
   g. Using the Identifier when comparison shopping
   h. Using the Identifier to access product specific data
   i. Using the Identifier to request retailer purchase incentives
   j. Using the Identifier to access affiliated products & services
   k. Using the Identifier to request Incentive offers
   l. Using the Identifier to reserve products for future purchase
   m. Using the Identifier to reserve entertainment event tickets
   n. Using the Identifier to reserve travel or lodging arrangements

PIP websites can be associated with Content in many different ways, for example, PIP websites for the show Lost can be categorized by year and series number for example, Lost—Season 1—Episode 1, 2, . . . 12 if there were 12 episodes in Season 1. A person watching say Lost Season 1 Episode 4 can go to the PIP based website and access products and services associated with this particular season.

Coordination between the eSafeAID media display device (800) and the eSafeAID conforming digital devices (such as the TV remote controller (804), cellular telephone (805), personal computer (806), etc.) occurs seamlessly whereby the customer simply request that the linked devices synchronize (via a device's ‘synchronization’ button, ‘authentication’ button, ‘purchase’ button, ‘Reserve’ button, and/or an ‘Authent-A-Purchase’ button) to the content that is being viewed. In this case, the cellular telephone, remote control, and computer automatically displays data corresponding to the Identified product, thus providing the opportunity and ability to authenticate products, purchase products, or reserve products. Also, this synchronization process can occur automatically where eSafeAID media device television program Identified products are automatically captured on an eSafeAID conforming device for either acquiring more data, reserving, ordering, purchasing, adding to a gift list or gift registry, etc.

A user may place a filter on the type of Original Content that they wish to receive by using their eSafeAID conforming digital devices filtering facilities. An example of applying a filter on Original Content involves a “cat lovers” desire to automatically capture cat information & data, incentive offers, and new cat products (food, vitamins, kitty litter, etc.) data directly onto their eSafeAID conforming devices.

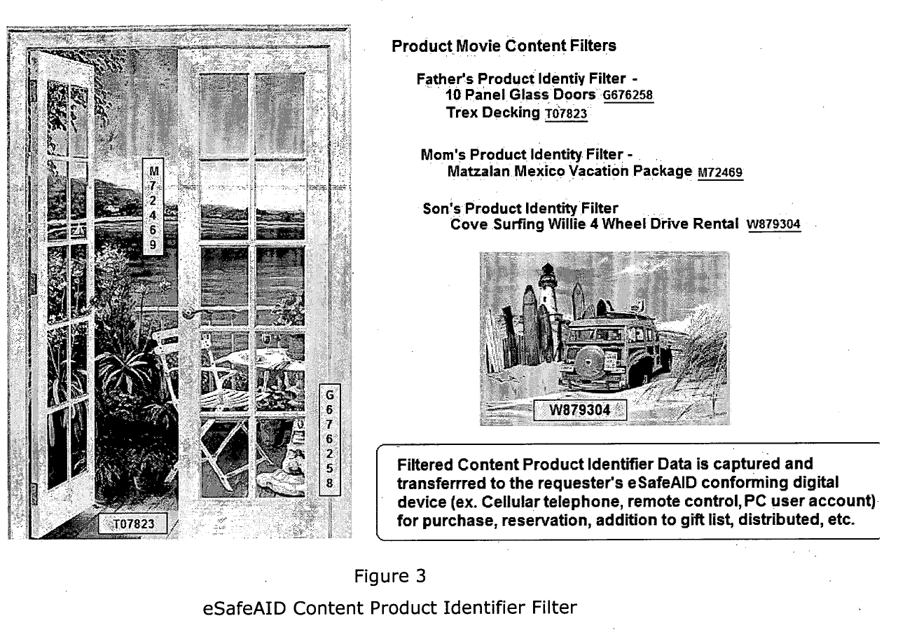

Each member of the family can have their own individual content identity filter (FIG. 3)—that collects product Identifiers, service Identifiers, and topics of interest Identifiers for specific individuals during a single movie, television program, entertainment event, sporting event, commercial, documentary, financial show, travel show, etc.

An example of individual content identity filter applied to a single entertainment program consists of, but is not limited to the following:

Daughter—hair styles, clothes and cosmetics of actors matching her age group are transferred to her personal computer, cellular telephone, or conforming eSafeAID digital device, which can be ordered, purchased, reserved, placed on a gift list, and also be distributed to family members, friends, and co-workers. Also, how-to workshops on the new hairstyle and makeup can be scheduled for her attendance.

Mom—captures meal recipes that are interesting and nutritionally sound, requesting the cookbook publishers be notified that she may desire complimentary recipes from the same cookbook as the one she had captured. Order ahead technology allows the mom to submit the recipe's item Identifiers from her content filter to her favorite supermarket for item pick-up or delivery. The service determines if all the necessary items for the recipe are available and issues a confirmation if all items are available. The mom orders all items to be assembled for the recipe along with items from her shopping list that is sent to her favorite supermarket, such as “Wegmans Foods Store”, where the staff grabs all items on her lists prior to her arrival.

Son—interested in a surfboard used in the program's content—synchronizes his personal computer to visit the surfboard's web pages and issues a request that direct purchase incentives be sent to both his and his mom's email account. Various media content depicting the surfboard is emailed to the son's personal computer or cellular telephone. Also, the surfboard is added to his gift ‘wish’ list.

Dad—interested in travel opportunities to the area contained within a movie or television show, request that rich content can be distributed to his eSafeAID devices along with ebrochures, points of interest, family amusement events that correspond to his personal and family interests, lodging requirements, available travel deals and trip purchase incentives, etc.

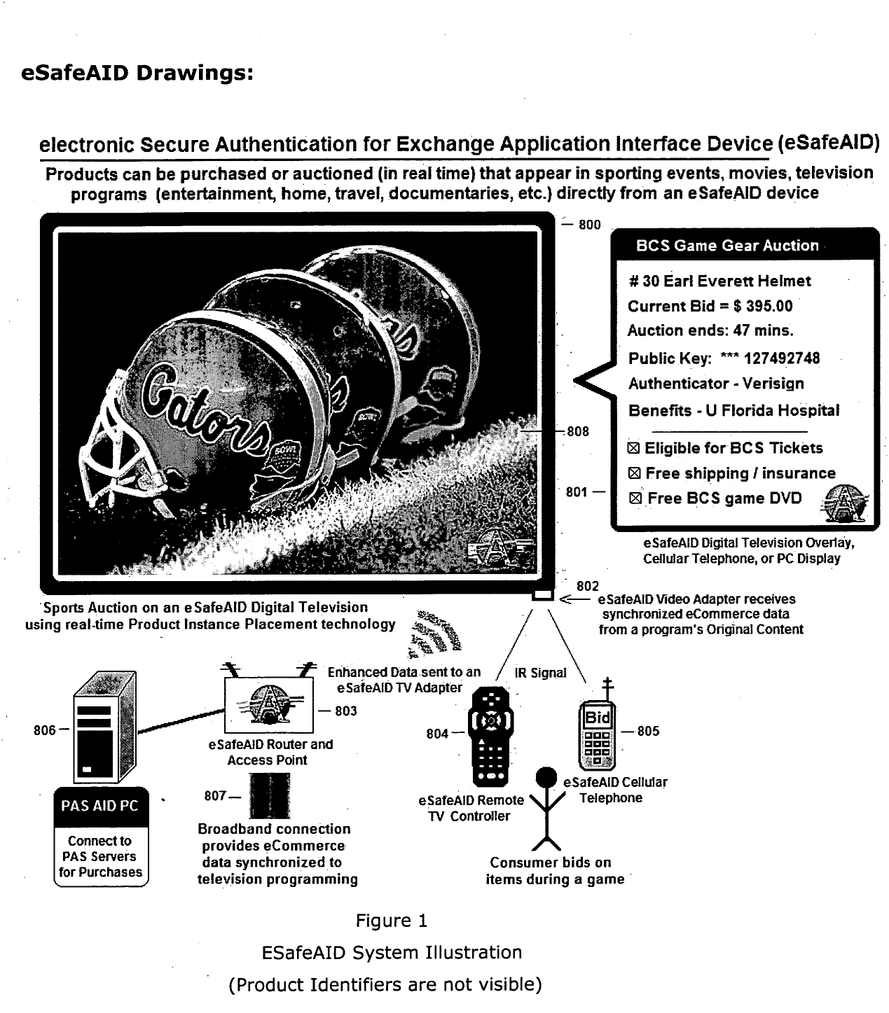

Optionally, the eSafeAID system facilitates automatic reserving or ordering of products pertaining to a particular category and/or offered by a specific manufacture or retailer and/or subject to a specific incentive offer. Also, the eSafeAID system facilitates participation in auctions (FIG. 1) and the placement of auction bids (801) on products Identified within Original Content (808).

In a similar fashion a home shopping TV channel can offer items from a particular show presenting the items based on Identifiers for which the home shopping channel builds product offering videos or advertisements displays, or on-line web access portals or web pages, or any other form of commercial or e-commerce methods.

Secondly, a product or service's Identifier may be used to re-broadcast Original Content from Movies, television shows, sporting events, entertainment events, commercials, etc., from a web site, portal, or shopping channel, broadcast channel, etc., thus re-displaying the product within its Original Content at the requester's discretion.

An electronic Secure Authentication for Exchange Application Interface Device (eSafeAID) is comprised of the electronic circuitry or software or a web service or a proxy service that can be used to identify, search, display and purchase products or request services in several configurations, such as—but not limited to:
Products or offers displayed within any type of Content or display including but not limited to television commercial, satellite radio commercial, terrestrial radio commercial, television show, game show, video, video game, movie, infomercial, news event, home shows, sporting events, travel offerings, etc. are capable of being purchased, auctioned, located, reserved, or added to a ‘shopping list, favorites list, or gift registry’
Services displayed within any type of Content or display including but not limited to television commercial, satellite radio commercial, terrestrial radio program broadcast or commercial, television show, game show, movie, infomercial, news event, home shows, sporting events, travel offerings, etc. are capable of being requested, ordered, scheduled, or identified for additional information request
Travel reservations, Airline reservations, vacation package offers, tours, trips, transportation excursions, adventures, etc. can be reserved and booked through a Travel Agency or agency to interesting and exotic locations or events depicted in any type of Content or movies, television shows, radio programs, travel shows, infomercials, gardening shows, entertainment events, sporting events, sporting venues, etc.
Products or services presented to PAS customers are capable of being captured by a conforming AID device and electronically forwarded to family members, friends, or colleagues
Desired products and services are searched via a conforming computer's webpage, cellular telephone's hosted eCommerce site, menu system, digital video feed, or an array of communication messages provided by manufacturers, retailers, distributors, brokers, promoters, etc.
Search result's product images, details, summarized and expanded data are displayed on a digital television via wireless communication with the conforming computer, cellular telephone, or another eligible digital device. Search results product Identifiers can then be used to replay or re-broadcast the video stream or broadcast of the product as it appeared within the original content
Additional product data, details, video, ratings, are provided to the customer's conforming display device(s) for immediate or eventual review via customer interaction. For example, a product Identifier can be used to access specification data for the product such as its manufacturer, model, rating, availability, physical dimension, etc. In addition, the Identifier can be used when comparison shopping on the Internet or when any other form of comparison shopping is being performed
Retailer's convey Direct Incentive Authentication Link offerings to the customer's conforming display device to persuade the customer to purchase the product
The customer conducts a partial authentication challenge (see below) of the product to acquire the product's encrypted public key from the Retailer
The desired product can be located ‘locally’ within a specific geographic area or from a preferred retailer enabling a customer to order the product directly from a retailer for pick-up or delivery
A reservation can be placed on a product, event, service, incentive, thus “holding” the product, event, service, incentive for a defined period of time for eventual purchase within a retail environment or an on-line eCommerce site, etc.
A digital television's conforming remote control, cellular telephone, or aforementioned conforming device is used to complete the product purchase or service purchase transactions
PAS user's can optionally be required to supply personal authentication codes and/or fulfill biometric challenges prior to enacting any purchase transactions or ordering any services in accordance with the user authentication requirements of the previously referenced patents
Accepted DIAL incentive offers impact the financial settlement of the product being purchased and are duly recorded within the PAS System
Financial Settlement may be conducted by credit card, debit card, electronic funds payment, COD, bank check, digital payment service, etc., or any form of payment service that facilitates the transfer of funds for the purchase of goods and services in the appropriate currency required within the terms of the specific transaction
PAS customer's are presented with the opportunity to take advantage of DIAL Incentive Offers associated with their purchased products, auction acquired products, or service ordered—at the time of purchase or at some point thereafter
PAS customers may ‘revive’ previously extended DIAL Incentive Offers by accessing their “purchase or service” history and review or enact their previous extended incentive offers and additional enhanced services the that had been presented
Upon completion of the purchase transaction, transaction receipts, confirmation, and pick-up or delivery information is electronically communicated to one or several of the customer's conforming devices

An eSafeAID cellular telephone can control an eSafeAID media display device such as a Television, DVD player, or gaming console, on a ranked basis. A parent's cellular telephone has precedence over their children's access rank, and can assign a ranking amongst their children's accessible telephone network. Also, a guest cellular telephone can also be given eSafeAID interaction privileges.

Furthermore, the intent of this invention links and expands a multitude of services provided to customers within the aforesaid patents to safeguard purchases of products and services in a safe authenticated manner thereby providing PAS customers the maximum level of insurance guaranteeing a product's e-pedigree, validation, and authenticity against counterfeiting, pirating, being stolen, damaged, recalled, unlawful, defective, etc.

In a typical electronic Secure Authentication For Exchange Application Interface Device (eSafeAID) configuration and usage, a PAS customer will be able to interact with eSafeAID devices in a manner such as, but not limited to the following:

While watching a television program or commercial, movie, DVD, game show, sporting event, concert, etc., a PAS customer sees a product of interest and decides to request more information for that product by pressing an “A” or “Authent-A-Purchase” button (or menu/tagging symbol), then an “Additional Data” option on their conforming television's remote control, or by pressing a “More” icon displayed on a computer screen, television screen, or other graphic display or icon, thus used to activate or indicate more information is requested. A communication signal is transmitted from their television's user interface interfacing to an application or a service thus providing coordinated product eSafeAID system functionality and retrieves the associated additional data for the desired product or service from the appropriate retailers, manufacturers, distributors, broker, or service provider affiliated with the eSafeAID Purchase Authentication System. The additional data may be displayed on their television or another eSafeAID media display device, computer, cell phone, or other electronic device and optionally also stored on their personal computer, cellular telephone, and/or other conforming eSafeAid conforming electronic device for later retrieval.

Alternatively, a PAS customer may purchase a product directly foregoing the transfer and review of addition product or services data.

When using a cellular telephone to conduct a purchase, an eSafeAID PAS Customer is protected against unauthorized or illegal usage of the cellular telephone to purchase goods through “Say buy it” voice security system technology. The “Say buy it” voice security system technology digitally compares the voice (audible voice print) of the individual conducting the transaction to that of the acknowledged owner of the cellular telephone. In instances when the spoken voice is not recognized as the voice print of the owner or an authorized family member (children or spouse) the cellular telephone is temporarily locked from future purchases and usage until such time an “reset” voice command is submitted to the system by the cellular telephones owner.

Children may use their cell phones to capture product identifiers from content and transfer product details and product identifiers to their parent's cellular telephone for review, reservation, and or purchase.

Should the customer decide to purchase the product, optionally, they may perform a real-time “partial” authentication of the product and receive a “purchase recommendation” from a trust authority (such as Verisign) which either guarantees the authenticity of the product subject to purchase.

The performance of a product's “partial” authentication challenge prior to its purchase utilizes the retailer supplied product's public key for a comparison check to the actual corresponding public key held by the trust authority for that specific product. Should the retailer supplied public key match the public key held by the trust authority, the product is considered “partially authenticated”, and the customer is advised to purchase the product and to perform a full authentication challenge once the order product is received. The product's public key is then stored within the eSafeAID data tables and is retrieved for later usage during the full authentication challenge (see below).

The trust authority uses the product's public key that the retailer provides as an indication that the subject product appears to be authentic. Such “purchase recommendation” is an initial indicator that the subject product is either available, or available and authenticated (partial or fully). Such “purchase recommendation” results from one or more steps of an authentication process being performed in the electronic device, or when electronic device cannot perform such processing the “purchase recommendation” processing can be performed by a computer server, network device or appliance, or web service, or web application, or another application or service.

For services that are considered for purchase, ordering, or scheduling, a PAS customer may review the service rating, better business records, governmental consumer complaints data, etc., when available, for the service provider and complete the service order or locate another service provider offering similar services in accordance with their specific preferences or meeting their service rating requirements.

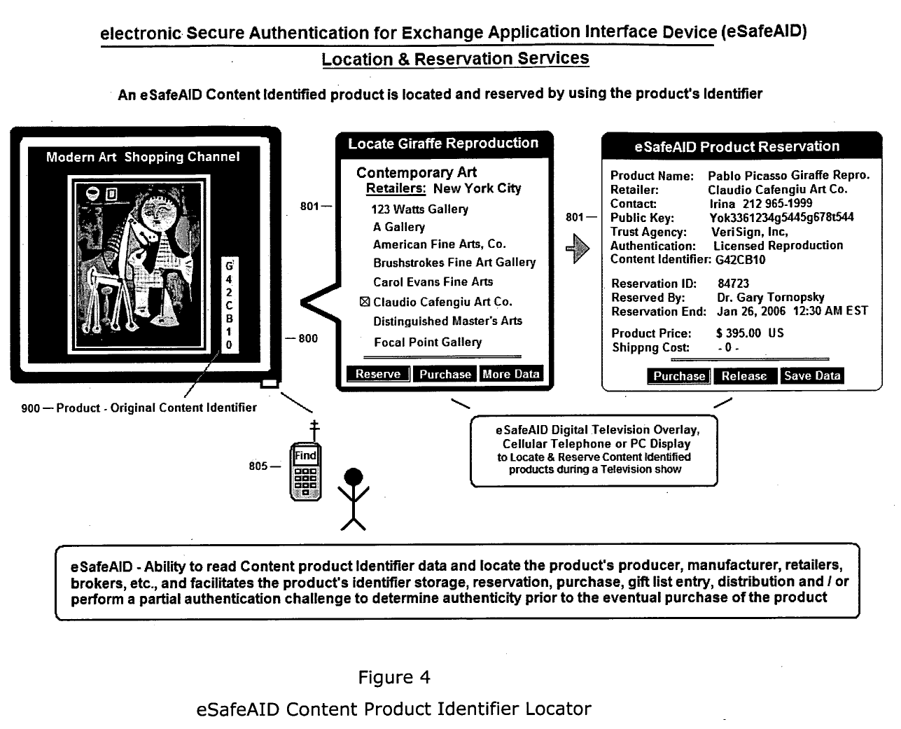

For products or services displayed on eSafeAID media display devices, a PAS customer may initiate a “product or service location search” (FIG. 4) which finds the product offered for sale and/or auction directly from any manufacturer, retailer, distributor, supplier, broker, service provider etc, offering or responsible for the purchase of the desired product or service. Similarly, a real-time “partial” authentication challenge may be performed on products or service ratings may be reviewed for service providers.

For the product and services ‘locator’ portion of this invention normal computers, cellular telephones, and eSafeAID conforming devices are used to find products that are within the physical proximity of the consumer or a within a designated search location (such as within 3 miles of the next airport someone is arriving at). The basic concept of the product location finder portion of this invention provides the ability for a potential customer to locate products or services appearing in real-time during an entertainment events, movie or media streaming, television program, sporting event, news, game show, entertainment event, movie, documentary, infomercial, commercial or thereafter during playback or replay or inclusion of the original event containing an Identifier in a news clip or talk program or other program including a video game, documentary, viewing in DVD movies, etc., or any media format providing a means to display the original content, by using their automotive or personal navigation system enhanced with product location services whereby a navigation system can identify stores or services providers, within a specific area when searching for products by detecting stores within that area and then checking the store's status for availability (and optionally pricing, store rating, return policy, incentives, etc.) of the desired product. The basic concept of the part location finder portion of this patent does not require the authentication elements described in this and prior patents and can be used in a standalone manner. In addition, the basic product location finder portion of this invention does not even need RFID tags and product location information can be obtained using barcodes or product IDs (not stored in RFID tags but printed on a barcode, website, eCommerce data feed, on-line catalog, magazine, news paper, etc.) and other non-RFID identifiers that can be used to indicate a product or services for which the nearest physical location can be found.

When a product is received from an on-line supplier, mail order supplier, a retail store that had provided its delivery, etc., the PAS customer uses their authenticated cellular telephone's RFID reader to verify that the purchased product they have in their possession is the exact authenticated product that was initially ordered by commencing a real-time product re-authentication.

Within this application, a reference to a product or service shall be identified simply as a “product”.

Upon successful identification of the product or service from within the PAS media conforming device, the product's relevant RFID and product data such as, but not limited to (manufacturing details, model, size, color, participating retailers offering the product for sale or auction, its usage and safety details, price, availability, release dates, anticipated ship dates, service rating, etc.) are communicated to the eSafeAID media display device, cellular telephone, PC's web browser or another conforming eSafeAID media display device. The PAS customer then requests a listing of retailers or service providers offering the product for sale or service meeting their specific pre-defined characteristics and then selects a retailer or service provider from which to purchase the product or service from.

Alternatively, the PAS customer may conduct a secondary search for the desired product retrieving product data from retailers other than those within their initial search. Secondly, a PAS customer may search for products that are similar to the initial product of interest, but possibly of a higher quality quotient, newer model, more appropriate model, size, color, or other details, from a more accessible retailer location, availability, or offering a more desirable factor.

At some point, the PAS customer uses their conforming eSafeAID device (ex. Digital television remote control or cellular telephone) to press an “A”, or “Authent-A-Purchase” button that automatically creates and submits a product purchase request that is communicated to the selected retailer. Such authenticated purchases can also be automatically performed by a Web Service or PAS Proxy Service. The retailer responds by acknowledging the request and optionally returns the product's trusted encrypted public key element and any relevant pre-purchase details. Once the trusted encrypted public key is obtained, the customer may optionally conduct a real-time “partial” authentication challenge (see below) and may eventually perform a full authentication challenge once the order product is received into their possession.

Alternatively, the PAS customer may use their conforming eSafeAID interactive device to search for sought after products and once it is digitally located, a PAS customer may place a digital “hold & reservation” on that product for their exclusive purchase and arrange for its subsequent pick-up or delivery. The PAS customer will have a predetermined “reservation period” for the located product and must purchase that product from the given retailer before the reservation lapses. When a reservation lapses, a PAS customer may “renew a reservation” on the product should the product remain available without any other “holds” placed upon it. In situations where a PAS offered product is in short supply and is currently reserved by a particular PAS customer, another PAS customer may be placed on a “waiting list” should the initial PAS customer's reservation lapse as described above. Should the reservation lapse on a reserved product, the next PAS customer is automatically advised of the current availability of the product via their conforming eSafeAID device and given the opportunity to place their own “digital hold” on that product or enact an immediate purchase transaction.

Advisories for upcoming product releases, services offerings, concerts, entertainment events, sporting events, etc. may be automatically communicated to PAS customers in accordance with their preferences and displayed onto their conforming eSafeAID media display device and purchased or reserved using their eSafeAid controller devices.

Tickets to a sporting or entertainment event can be located, reserved and/or purchased in a secure authenticated manner under the aforementioned patent safeguards by using an eSafeAID conforming device.

For tickets to a sporting game, vacation or entertainment event, a PAS customer can order and purchase tickets and services directly from their eSafeAID media center which may include: travel (air, limo, cab, bus, train, etc.), lodging, and party packages. Any element of the package may be depicted by a corresponding infomercial, streaming video, audio, web page, in accordance to the user's requested time specification (1, 3, 10 or 30 minutes, etc.) Full details of the event, destination, flight, limo, hotel, etc. may be transferred to the user's conforming eSafeAID device's calendar. All such Tickets purchased within the PAS system are authenticated against counterfeiting, pirating, being stolen, damaged, unlawful, recalled, etc., prior to purchase and upon their reception.

PAS customers may enroll on a waiting list for tickets to sporting events, concerts, theatre, entertainment events, etc. prior to the events ticket release date through the auspices of event ‘pre-purchase offerings and agreements’.

Movie, Television Programs, Sporting events, Commercials, News, Game Shows, Documentaries, or an Entertainment Event's digital media (streaming, play-back, terrestrial, satellite television, satellite radio, high definition television, digital transmission, broadcast transmission, wireless transmission, cellular telecommunication transmission, and/or broadband transmission) present to PAS customers an opportunity to directly purchase associated products, services, props, gear, etc., related to the movie, television program, entertainment event or from the sporting event from “retailers, manufacturers, producers, promoters, etc.” in a secure authenticated way using their conforming eSafeAID device.

The aforementioned Product Instance Placement “PIP” (901) facility uses a time-based interval coordination system to present products or services that are presented to PAS customer's eSafeAID media display device and accessible by an eSafeAID conforming controller device to either purchase, reserve, locate, order, acquire data about, capture the product's details onto another eSafeAID device, in real-time during an entertainment events media streaming, television program, sporting event, news, game show, entertainment event, movie, documentary, infomercial, commercial or thereafter during a movie's playback, sporting event replay, video game, documentary, viewing in DVD format, blue ray format, etc., or any media format providing a means to associate product purchases dynamically linked to media content.

Captured eSafeAID Content comprised of product Identifiers on one eSafeAID conforming device may be seamlessly transferred to another eSafeAID-conforming device as the need presents itself. An example of such a compiled product Identifier list transfer among eSafeAID devices entails a Mom compiling a holiday gift list for desired products previously seen during television programs and commercials that are then transferred to the conforming cellular telephone of her husband. The husband then enacts a “product location search” whereby the eSafeAID product finder locates the products and identifies the local retailers offering the exact products of the gift list. At that point, the husband can place “reservations or holds” on the products and transfer the retailer's physical street addresses onto his automotive Global Position System that guides him to the stores containing the reserved products. The product's inventory information, availability, reservation status, prices, etc. may be data elements that are transmitted from the retailer's to the Global Positioning System Graphical User Interface display device.

An example of another associated eSafeAID media product purchase transactions is based on Rayban Corporations offering for direct purchase to customers via an interactive device (preferably a conforming eSafeAID interactive device) the identical “sunglasses” to those worn by actor Tom Cruise in the movie “Risky Business”.

Another example involves the New York Mets Organization offering for direct purchase to PAS customers “autographed game day baseball jersey” of All-Star Third Basement David Wright. In both instances, the PAS customer can perform a real-time partial authentication challenge prior to the purchased products and once successful can complete the purchase transaction. Eventually, the customer can optionally issue a full authentication challenge once the ordered product is received.

To enhance a Movie experience, PAS customer may use their eSafeAID interactive device to interact with Movie content within an eSafeAID media display device or within the interactive tracks of a movie digital video disk (DVD) to purchase products such as soundtracks, costumes, movie props, products used by actors within the movie, movie related interviews, stories, books, sequels, etc., or arrange for trips to actual movie filming sites, or play related games, participate in trivia contests, etc. For upcoming movies, PAS customers may arrange for stays on or near filming site packages by utilizing the travel and lodging services referenced above.

### Live Entertainment Event Capture

Within an entertainment event such as a concert or theatre play, an eSafeAID conforming device may be used to order and receive Original Content “live” songs or “live” performance media as the concert or play is occurring. In this instance, an eSafeAID broadcast content distribution engine will push down the live performance to the eSafeAID conforming device for later replay. Pre-concert media distribution reservations may be made that optionally includes incentive offers, such as, but not limited to, backstage pass upgrades, dinner with the band, reservation for upcoming concerts, on-line chat sessions with the performers, exclusive band CD and/or DVD purchases, parties with the band, etc.

Game Day Sporting Gear can be offered for sale to PAS customers over their conforming eSafeAID devices consisting of (but not limited to): worn uniforms and apparel, balls, bats, gloves, pucks, sticks, golf clubs, fishing gear, etc. Such sporting items may even be placed into an eSafeBay auction during the game while it is in progress and each item is digitally identified by its corresponding rfid tag id or unique id. Also, identical or replica sporting gear, balls, fishing, golfing, hunting, racing, and other products, etc. may be eligible for direct purchase to PAS customers as well as any retailer presented DIAL Incentive Offers (see below) using their conforming eSafeAID media video devices and interactive controllers.

An auction winner may also utilize DIAL Additional Services (see below) to establish PAS automatic ownership, insurance, collateralization, register with broker services for potential re-sale of the item, etc.

Video footage, digital images, and/or audio files of the most interesting play or scene involving the purchased product may be written to the storage area of the rfid tag (when appropriate) or captured for, later retrievable to a conforming eSafeAID media device.

PAS customers may also order physical paper-based and/or Authenticity Certificates detailing the products origin and history that may be applied or digitally associated to the purchase or acquired at auction.

Derivative PAS user software can include optionally associate their own data/details regarding the product item by writing such data to the rfid tag's memory region.

PAS customer or owners of valuable products may commission an electronic statement from the Movie's actor, composer, producer, writer, director or sports player, athlete, coach, etc. be composed and digitally written to the rfid tag's memory region.

PAS eSafeAID Trip Assist Technology:

This eSafeAID invention further establishes the ability to find products and services directly from your auto, by wireless “wi-fi” and/or “rf” (radio frequency) communication or through a Global Positioning System (GPS) satellite coordination system.

PAS eSafeAID Trip Assist provides the ability to plot and reserve a trip via an eSafeAID content Identifier package, as content identified within in a movie, television program, travel show, documentary, a website, travel club email, trip incentive package offer, magazine, newspaper, brochure, etc.

In a sense, the eSafeAID GPS system may be considered a Global Purchasing System, providing the ability to purchase and reserve products, services and entertainment tickets during a trip, from its beginning to its end, such as, but not limited to the following:
Hotels by preference
Restaurants achieving a desired Zagat rating
Scenic locations—by favorite travel book edition
Entertainment—by preference or recommendation
Amusement—by kid preferences
Festivals—by hobbies, interest
Information—about the towns and regions traveled through with the ability to further capture product identifiers, location identifiers, hotels, cuisines, entertainment, etc.
Geographic information
Educational tie in to school assignments & special projects

Furthermore, the ability of customers to use their eSafeAID conforming devices to view, research, and reserve travel accommodations, lodging, dining, amusement activities, entertainment, sporting events, etc., prior to the trip's commencement, that is dynamically linked to a customer's distinct interests, or as presented by a trusted travel facilitator, or contained within Original Content of a movie, television program, travel program, provides an integrated opportunity for customers to receive direct travel related incentive offers corresponding to the trip's itinerary.

For instance, a baseball fan interested in a tour of the ‘greatest baseball parks’ may reserve a Major League Baseball presented ‘fantasy baseball vacation package’ that includes air travel, hotel accommodations, meals with players, managers, broadcasters, Hall of Frame members, etc., for major league games as presented to fans during the Major League Baseball All-Star game or during the World Series Championship game for the next season and accessible for purchase or reservation to fans via the game broadcast of the corresponding ‘fantasy baseball vacation package’ Identifier. A fan could reserve the ‘fantasy baseball vacation package’ by using their eSafeAID cellular telephone and at their convenience viewing the package's details, such as the included ballparks, seat ticket locations, hotels, restaurants, cities, and associated entertainment that is offered by simply capturing the tour's Identifier and reserving/purchasing the package.

The customer can then use their eSafeAID cellular telephone to connect to an incentive network corresponding to their baseball package coordinated Identifier for the city location they are in or view any available product incentive offers by scanning RFID tags on products, restaurants, hotels, amusements, etc., at any of the cities they visit during the baseball package tour, or by simply requesting direct incentive offers for products and services they are interested in as communicated under the auspices of the Direct Incentive Authentication Link system offers (see below).

Order ahead technology could be used by PAS customers to order snacks in unknown cities by using their cellular telephone to identify and locate pizza restaurants matching their preference and Zagat Rating. The pizza restaurant ‘pickup’ location coordinates are communicated to the customer's eSafeAID conforming component's GPS system that alert's the pizza restaurant when the customer is within x minute of the restaurant for the pizza pickup.

Restaurant reservations may be sought and made when a customer uses their eSafeAID conforming device to seek out restaurants that meet their preferences such as cuisine, ambiance, and quality rating.

Restaurant order placement may alert the host of the restaurant which appetizers to prepare when a customer's emergency hunger must be dealt with.

PAS customers may also receive “DIAL Incentive Offers” or “Enhanced Additional Service” offerings associated with their product purchase or auction acquisition or product reservations or service reservations as those contained within the “Direct Incentive Authentication Link (DIAL) System”, such as:

### DIAL Incentive Offers:

PAS presentation of DIAL Incentive Offer messages may include, but are not limited to:

| | |
|---|---|
| Savings | Save 20% on this item |
| | Save 10% on associated accessories |
| Bonus | Free Item: Buy the pocketbook now & |
| | receive a free matching wallet |
| | Earn Points: Earn double bonus points for |
| | this purchase |
| Locate | Locate this product in my: |
| | Area, Size, Color, Model, etc. |
| Order | Direct from Manufacture if the desired item |
| | is not available for purchase immediately |
| | from the Retailer |
| Compose List | Add this item to my shopping/wish list |
| | Add this item to my Gift/Wedding registry |
| Invitation | Complete a product satisfaction survey |
| | Suggest how we can make this product |
| | better |
| | Join our Frequent Buyers Club |
| | Receive new product announcements |
| Enrollment | Participate in a Product Launch Celebration |
| | Subscribe to a ‘branded’ life style magazine |
| | Contribute toward Product Research & |
| | Testing |
| | Join a Product Focus Group |
| | Enroll in Product Protection/Service Plan |
| Credit Card | Increase your Credit Limit |
| | Use your Bonus Rewards toward this |
| | purchase |
| | Upgrade your Credit Card Club Level |
| | Earn Double Bonus Rewards |
| Added | Include complimentary Services with this |
| Services | purchase |

### Enhanced Additional Services:

Electronic Ownership Registration
Electronic Completion and Electronic Filing of Rebates
Product Service Plans
Product Performance Insurance Plans
Automatic Periodic Authenticated Product Ordering Agreement
Collateralization Services
Electronic Product Appraisal Services
External Product Appraisal Services
Product Valuation Certificates & Product Ownership Certificates Services
Broker Services
Direct Incentive Authentication Link Post Purchase Offer Availability

### Partial Purchase Authentication:

A partial authentication challenge involves the establishment of a (possible simultaneous) connection to a Trust Authority that will verify the appropriateness and validity of the product's public key (previously provided by the retailer to the customer) to the product's stored public key and ancillary RFID electronic product code and associated data that is stored and maintained by a Trust Authority (such as VeriSign).

Should a preliminary assessment of the retailer's data algorithmically match the Trust Authorities (such as VeriSign) public key and associated data, the customer is advised to complete the transaction for the desired product and the products public key is stored within the customer's eSafeAID cellular telephone, computer system or another eSafeAID device.

When the public key (previously provided by the retailer to the customer) fails validation and/or is deemed in-appropriate and does not algorithmically match the product's stored public key maintained by a Trust Authority (such as VeriSign), the customer is advised to “abort the transaction”. Should the customer's settings automatically prevent the purchase of products resulting in an Authentication Failure, the failed authenticated product may optionally be automatically blocked from being purchased.

eSafeAID Purchase Product Reception & Full Authentication Challenge

Once the ordered product is received by the PAS customer, the customer uses their conforming eSafeAID device's RFID reader to transmit the previously stored corresponding product's public key to the actual product's physically embedded or attached RFID tag thereby commencing an RFID authentication challenge commensurate with the technology incorporated within the “Security authentication system for collectible and consumer items” (U.S. patent application Ser. No. 11/157,282) and “Secure RFID authentication system” (U.S. patent application Ser. No. 11/268,162) and Secure RFID Authentication System using non-trusted communications agents” (U.S. patent application Ser. No. 11/728,792).

Should the product's encrypted public key algorithmically match the internal encrypted private key of the product's RFID tag, the product is considered to have passed the authentication challenge. At this point, a PAS customer is advised to accept the product as the “real product” identified at the point of purchase and incorporated within the PAS purchase order and purchase contract.

### Request Commercial/Data for a Specific Product

PAS customers that search a specific product, movie, entertainment performer, sporting event, athlete, etc. can view corresponding product, performer or event commercials and details on their conforming eSafeAID media video devices via a request enacted on their conforming eSafeAID interactive controllers. During the data or commercial's display on the eSafeAID media video device, a PAS customer can either select products, event tickets, etc. for immediate direct purchase, reserve such products, event tickets, etc. (as described above), perform product or ticket locator services, accept (DIAL) purchase incentive offers or extended services, and/or compile a shopping list or gift registry listing.

PAS customers may also request that upcoming ‘soon to be released’ movie/concert/sporting or entertainment announcements be queued for viewing on their eSafeAID media video devices. PAS customers may opt to automatically reserve or purchase desirable tickets once they become available for sale by using their conforming eSafeAID interactive controllers reserve or auto-purchase capabilities.

Additionally, PAS customer may locate restaurants within a given geographic area by rating or cuisine, and make electronic reservations.

Alternatively, PAS customers may even commission a “sanctioned” restaurant to prepare a meal to the exact details of their favorite movie while wearing replica outfits and replica dining accoutrements.

The invention claimed is:

1. A system to conduct the purchasing or auctioning of products and services or scheduling of services as presented to viewers or potential customers within a television commercial, satellite radio commercial, terrestrial radio commercial, television show, game show, video, video game, movie, infomercial, news event, home shows, sporting events, travel offerings, television program, game show, DVD, entertainment event, sporting event, travel show, documentary, financial show, commercial, infomercial, brochure, on-line web site, e commerce site, newspaper, magazine, book, journal, etc.

2. The system of claim 1 wherein said system is further comprised of and interacted with authenticated digital electronic communication devices such as—a cellular telephone, an RFID Reader, Secure ID reading, Personal Digital Appliance PDA, Personal Computer, Laptop or Notebook computer, electronic wallet, television, personal video player, digital television, high definition television, set-top box, satellite radio, satellite television, satellite internet, satellite telecommunication device, video gaming device, gaming device, gaming controller, video remote control device, television remote control device, Global Positioning System (GPS) and/or future electronic digital device combining one or more of the functionality currently provided by any single device to perform the purchase or auctioning or reserving or locating of products and services activities specified within claim 1.

3. A system comprised of authenticated and/or encrypted secure digital electronic communication devices declared of claim 2.

4. An integration of the devices of claim 2 whereas certain devices are capable of sharing data packets, information, or system commands to conduct transactions of claim 1.

5. A system employing Original Content Identifiers associated to products used to identify products contained within claim 1 and accessible from selectable devices of claim 2.

6. A method of employing a Product Instance Placement timing interval that coordinates claim 4 Original Content Identifiers to products and services during the a claim 1 presentation

7. The usage of “stealth” Original Content Identifiers that is not visible to the “naked eye” but detectable and subsequently visible and accessible by the devices of claim 2.

8. Product or Service Finder or Locater processes that uses claim 4 Identifiers to find or locate said products or services within a preferred territory or from a preferred manufacturer, vendor, retailer, rating, distributor, service provider, etc.

9. The capacity to facilitate the “reserving or holding” for purchase products or scheduling of services within claim 1 for a specific predetermined period.

10. A system that includes an electronic eSafeAID media display device adapter that presents and processes Product Instance Placement Identifiers within a said eSafeAID media display device as an overlay to associate Identifiers to products contained within content, whereby PIP Identifiers are associated with user interaction for selection of PIP Identified products with commands or triggers sent from conforming devices of claim 2 to acquire products, services, participate in auctions, etc. as described in claim 1.

11. The provision of Direct Incentive Authentication Link Offers and Enhanced Additional Service offerings to purchase or reserve products or auctions or services of claim 1.

12. The ability for customers to reserve or order tickets to entertainment events, sporting events, transportation, and/or hotel, lodging, amusement parks, resorts, or for travel excursions as presented within claim 1.

13. The ability to reserve and order live entertainment media content directly to a customer's conforming electronic device of claim 2.

14. The means to use an RFID reader or similar claim 2 device to authenticate products contained within claim 1. The system's capacity to perform authentication challenges in either a “partial” or “full” modality to authenticate products contained within claim 1.

15. The ability to offer customers real-time “live” auction participation or an opportunity to purchase items used during a sporting event, entertainment event, television show, news show, within claim 1 using devices of claim 2.

16. The ability of customers to place filters upon Original Content within claim 1 whereby said filters captures and store Original Content Product Identifier corresponding to their specific interest within claim 1.

17. The ability of the system to facilitate the replay of Original Content video or broadcast media feeds corresponding to the filter captured Original Content Product Identifier(s) of claim 16.

18. The ability of the system to facilitate customers in purchasing, reserving, ordering, scheduling or participating in auctions for Original Content Product Identifiers associated with products and services within claim 17.

19. The ability of the system to use a GPS system to research, purchase and reserve products, services, lodging, entertainment tickets, etc. prior or during a trip, from its beginning to end, by using the location services of claim 8.

20. The system also provides the ‘Order a Head Technology’ that automatically initiates alerts to retailers and service providers informing such businesses that your vehicle's location is within certain proximately of the establishment and will be arriving within a specific time frame. Order Ahead technology uses claim 2 devices and reservation of claim 9 and data sharing of claim 4.
